(19) United States
(12) Patent Application Publication
(10) Pub. No.: US 2015/0309496 A1
(43) Pub. Date: Oct. 29, 2015

(54) CONTROL SYSTEM AND METHOD FOR LANDSCAPE MAINTENANCE

(71) Applicant: K-Rain Manufacturing Corporation, Riviera Beach, FL (US)

(72) Inventors: Carl L.C. KAH, III, Riviera Beach, FL (US); Thomas PAVLIK, Riviera Beach, FL (US)

(21) Appl. No.: 14/617,519

(22) Filed: Feb. 9, 2015

Related U.S. Application Data
(60) Provisional application No. 61/989,150, filed on May 6, 2014.
(60) Provisional application No. 61/983,696, filed on Apr. 24, 2014.

(51) Int. Cl. G05B 19/042; A01G 25/16

(52) U.S. Cl. CPC G05B 19/042; A01G 25/16; G05B 2219/2625

(57) ABSTRACT

A landscape management method is disclosed. The method may include: populating an area of a map with information about a plant, for example a grass or a lawn, associated with the area; receiving from a sensor located in the zone, first data regarding the plant; comparing automatically, the first data with reference data of a plant of a same type as the plant, and making a determination, based on the comparing, regarding a landscape management action for the area; and transmitting a signal indicating the landscape management action for the area according to the determination. The comparing may entail image processing to determine vigor of the plant. Vigor may be determined by judging leaf width, coloration, or folding of leaves or blades with respect to a stolon or midvein or by other changes in leaf geometry. Repeated data sampling to identify and judge trends in plant health and condition may also be used.

### CROSS-REFERENCE TO RELATED APPLICATIONS

The present non-provisional patent application claims the benefit of priority from U.S. Provisional Patent Application Nos. 61/983,696, filed Apr. 24, 2014, entitled “CONTROL SYSTEM TO ENSURE TURFGRASS VIGOR” and 61/989,150, filed May 6, 2014, entitled “TREND-BASED LANDSCAPE MAINTENANCE CONTROLLER,” the entire contents of both of which are incorporated herein by reference.

### BACKGROUND

1. Field of the Disclosure

The present disclosure relates to a system for monitoring grass, including turfgrass, and automatically making decisions regarding irrigation and other lawn care based on comparison with threshold conditions.

2. Description of the Related Art

Turf grasses change over time as a function of many variables, such as hydration, nutrient availability, stressors, such as insects and disease, competition with other plants, and also undergo changes due to natural growth, seasonal changes, temperature and other factors. Depending on the species, grass may change in form, coloration or both due to various levels of hydration and due to nutrient availability, or from stressors. The coverage of ground provided by grasses may change due to these factors so that turf areas may appear relatively sparse or lush.

In some species, grass blades emerge from nodes on stolons, which spread over the surface of the ground. Other species may emerge as bunches or as single stalks/blades, or as combinations of these, such those whose bunches emerge from stolons. Grasses may present themselves in other forms as well. The appearance of grasses may also change due to the presence of inflorescences or seed.

Grasses advance through various means, including above the surface as stolons from which grass blades and roots emerge from nodes, from seed, from underground rhizomes and perhaps through other means. Advancing grasses can fill in weak spots to outcompete weeds. Advancing grasses may also encroach into plant beds, onto walkways or into other regions that are designed to be clear of grasses. Also grasses grow in height necessitating mowing.

Regular or frequent monitoring, analysis and care for a lawn, a sports field or pitch, a golf course, or the like can be time consuming and expensive. Such a process relies to some extent on the availability and time of human specialists and caregivers. It also relies on and can be adversely affected by the judgment of human specialists and caregivers as to the appropriateness of growth patterns, grass advance, grass coloration, irrigation sufficiency and the like for any given season.

As is well known in the prior art, plants, including hedges, shrubs, flowers and grasses respond to changes in temperature, soil moisture, sun and stresses in a variety of ways, including changes in color, changes in the folding of grass blades and the like. For example, the article “Drought Stress Indicators in St. Augustine Grass,” explains various indicators that can be used to check drought stress on certain grasses.

For typical irrigation controllers, the frequency of the actuation of valves may be controlled by a programmed timer. The days when the system is to be active are specified and the timing of valve actuation on those days is specified. Also for typical irrigation controllers, valve actuation may initiate due to data received from sensors such as moisture sensors or data from a rain catch-cup.

As will be understood further, machine vision techniques and sensing are well known. For example, Narra, Siddhartha, Evaluation of Sensing and Machine Vision Techniques in Stress detection and Quality Evaluation of Turfgrass Species, ProQuest/UMI, 2008; Watchareeruetai, Ukrit, Machine Vision and Applications, Volume 17, Issue 5, September 2006, Pages 287-289; and Meyer, George, E. Machine Vision Identification of Plants, Intechopen.com, publication, University of Nebraska, Department of Biological Systems Engineering, USA, provide such techniques.

Narra discloses an encoding algorithm for analysis of turf-grass texture, generating equations to represent leaf width, and calculating average leaf-widths of turf-grass canopies with the developed equations. Narra does not address that blade width is a function of blade maturity, and that the blade's maturity can first be determined by measuring ratios of length to width of blades within a turf-grass plot and then the vigor can be thus evaluated as a function of the blade width in view of blade maturity. Further, Narra does not address fold angles of turf grasses or analyzing them.

Watchareeruetai proposes methods for detecting textures of plants to indicate weeds in lawns by the use of computer vision techniques. Watchareeruetai teaches that weed detection rates of up to 90% are possible irrespective of lawn color, and that once the weeds are detected, two different techniques are suggested to exterminate the weeds.

In addition, Meyer, George, E. Machine Vision Identification of Plants, Intechopen.com, publication, University of Nebraska, Department of Biological Systems Engineering, USA, describes that blade-folding in St. Augustine grass is a drought-stress indicator and explains that visual observation of blade-folding can be used to diagnose drought-stress. Watchareeruetai and Meyer do not address the above shortcomings of Narra.

In addition, Bragg, U.S. Pat. No. 8,565,904, discloses an irrigation controller and system that determines a water budget for landscaping. Donahoo, U.S. Pat. No. 7,258,129, discloses a moisture sensor control system for sprinklers used in a landscaping system. Bragg, U.S. Pat. No. 8,565,904 and Donahoo, U.S. Pat. No. 7,258,129 are incorporated in full by reference herein. The articles, “Drought Stress Indicators in St. Augustine Grass,” Narra, Watchareeruetai, and Meyer are filed as attachments herewith and are incorporated in full herein by reference.

### SUMMARY OF THE DISCLOSURE

A landscape populating, landscape management and automatic landscape management signal generating method is disclosed. The method may include:

populating an area of a map of a zone with information about a first plant associated with the area;
receiving from a first sensor located in the zone, by a module comprising an automated processor, first data regarding the first plant;
comparing, by the module comprising the automated processor, the first data with reference data of a plant of a same type as the first plant, and making a determination, based on the comparing, regarding a landscape management action for the area; and
transmitting a signal indicating the landscape management action for the first area according to the determination.

The reference data may be data from a database, or may be data collected earlier for the plant or a leaf of the plant or an average, mode or median of such collected data. In the latter case, the reference data is data from the same plant as the first plant.

In such a method the first data may represent an image of the first plant and the comparing comprises image processing to determine vigor of the first plant.

The determining of the vigor may be performed by judging a leaf width of the first plant. The determining of the vigor may be performed by judging a coloration of the first plant. The determining of the vigor may be performed by judging a color of a tip or an edge of leaf or a blade of the first plant. The determining of the vigor may be performed by judging an amount of coverage by the first plant of the first area. The determining of the vigor may be performed by judging a folding of a leaf or blade of a first portion of the first plant with respect to midvein or central line of the first plant.

The plant may be a grass.

The method may further comprise: retrieving the reference data from a library remote from and, connected via a data network with, the module.

The Method May Further Comprises:

receiving at a time remote from a time of the receipt of the first data, from the first sensor, second data regarding the first plant, wherein the making the determination comprises judging a trend in a condition of the first plant by comparing the first data with the second data.

The Method May Further Comprise:

judging a maturity of the first plant based on the first data,
wherein the making the determination is based on the maturity judged.

The judging the maturity may include determining a width of a blade or a leaf of the first plant in relation to a length of the blade or the leaf.

The Method May Further Comprise:

determining, based on the first plant, a landscaping supply list for the area; and
outputting the landscaping supply list to a user.

The Method May Further Comprise:

populating the map with further information about the zone, wherein the landscaping supply list comprises irrigation equipment, and the determining the landscaping supply list is based on the further information about the zone.

The method may further comprise generating an irrigation schedule according to the determination regarding the landscape management action.

The signal may be transmitted to at least one of an irrigation system, mowing equipment and trimming equipment.

Also contemplated is a landscape management module, system or method. Such a module may include an automated processor communicatively connected to a first sensor located in a zone, the module comprising:

a receiving module configured to receive populating data about a first plant associated with an area of a map of the zone;
the receiving module configured to receive, from the first sensor, first data regarding the plant;
the receiving module configured to receive, from the first sensor, at a time remote from a time of the receipt of the first data, second data regarding the first plant;
an analyzer configured to compare the first data with reference data of a plant of a same type as the first plant, and to judge a trend in a condition of the first plant by comparing the first data with the second data;
the analyzer configured to determine, based on the judging, a landscape management action for the area; and
the module configured to transmit a signal indicating the landscape management action according to the determination.

In such a module, the determining the landscape management action may include deciding to irrigate the area when the trend shows declining vigor for the first plant.

A landscape map populating, landscape management and automatic landscape management action signal generating system is also described. The system includes an automated processor communicatively connected to a first sensor located in a zone, the system comprising:

a populating data receiving module configured to receive populating data about a first plant and location data for associating the first plant with a first area of a map of the zone;

a sensor data receiving module configured to receive at a first time, from the first sensor, first data regarding a condition obtaining in the first area;

the sensor data receiving module configured to receive, from the first sensor, at a time subsequent to and remote from the first time, second data regarding the condition obtaining in the first area;

an analyzer configured to compare automatically the first data with the second data and to judge a trend in the condition in the first area;

the analyzer configured to determine automatically, based on the judging, a landscape management action for the area; and

the system configured to transmit automatically a signal indicating the landscape management action according to the determination.

In such a system, the trend judged may include a change in a rut size in a ground in the first area, and/or the trend judged may include at least one of a change in a blade thickness of a grass, a change in a blade fold angle of the grass with respect to a midvein or central line, and a change in coloration of the grass.

Other features and advantages of the present invention will become apparent from the following description of the invention which refers to the accompanying drawings.

### BRIEF DESCRIPTION OF THE DRAWING

FIG. 1 illustrates an example of components of a landscape maintainer, according to an aspect of the present disclosure.

FIG. 2 illustrates and example of a system diagram showing landscape maintainer in relation to other system components, according to an aspect of the present disclosure.

FIGS. 3A-B illustrate an example of a flowchart showing an operation of the landscaper maintainer, according to an aspect of the present disclosure.

### DESCRIPTION OF THE DISCLOSURE

While examples herein will be given with reference to grasses, lawns and turfgrass, it will be understood that the system as described herein may be applicable to other kinds of landscaping, gardening and plant maintenance, including vegetable patches and farms, grain production, orchards, flower beds, legume production, nurseries and tree cultivation and pruning, as well as other agricultural landscaping applications.

A computer system and software platform according to the present disclosure implements a set of algorithms on a CPU by reference to a database of grass information and/or a photo library of images. A landscape-maintenance controller (LMC) incorporates or has access to a database, library or other means of storage of images of healthy/lush grasses of various species.

For example, Michigan State University Library has the Noer/MIlorganite® Image Collection. The collection features 14,000 35-mm slide images, including color photographs and including close-up images. The collection includes close up photographs of many varieties of grasses, disease, pests and turf-based landscapes, and is being digitized for public access at http://noermmsd.lib.msu.edu/. Software applications for smartphones, such as “Turfgrass Management,” created at the University of Georgia, contain pictures, information, and recommendations for managing turf. Also subscription-based online resources, such at the Plant Management Network website http://www.plantmanagementnetwork.org/images/ provide image databases which include turfgrass images. It will be understood that these are examples and that other sources of reference photographs and information, and combinations of the foregoing, may also be used.

Such images may be either acquired or generated. The LMC may also incorporate a database or library of geometries that describe turf-grass blades and other structures including dimensional information and ratios.

The aforementioned LMC may also incorporate a database or library of images and/or geometries that describe stressed turf-grass blades and other structures including dimensional information and ratios. And furthermore the LMC may:
incorporate a vision system that can acquire and store images of turf grass areas and of areas designed to be clear of grasses;
allow access to or incorporate a database/library of local, seasonal data for rainfall, solar incidence, and temperature;
receive data from transducers such as moisture sensors, temperature sensors, infrared detectors, solar incidence detectors, and ph transducers, etc.
incorporate one or more algorithms to reduce image data to dimensions, ratios, shapes, and/or into other geometrical information, useful for comparative or other forms of evaluation;
incorporate one or more algorithms that compare acquired images with other acquired images and/or threshold data;
incorporate one or more algorithms to compare acquired images with database/library images and/or threshold data;
incorporate one ore more algorithms that compare stored data, such as images day to day, to detect and record trends, to compare growth and other patterns, and to make predictions based thereon; and
incorporate one or more algorithms that utilize data from images as inputs to make decisions on irrigation schedules and/or other care decisions, and/or to send out advisories or alerts.

For example, Fraunhofer provides hyperspectral imaging technology and grass imaging at the website http://www.iws.fraunhofer.de/en/business_fields/chemical_surface_reaction_technology/process monitoring/technologies/hyperspectral_imaging.html A company called IXION provides custom vision system development services for various applications http://www.ixion.es/technologies/ComputerVision.html Custom imaging solutions are also provided by IMPERX http://imperx.com/custom-imaging-solutions/

Examples of vision systems developed for environmental monitoring may be found at http://www.vision-systems.com/articles/2013/01/vision-based-system-monitors-the-environment.html

An example of how the system would use moisture information acquired by a sensor is as follows;
1) Using data from a sensor a quantitative/mathematical representation of the moisture level is generated by an algorithm. For instance a voltage signal of a certain magnitude is output by the sensor and this is converted to a number representing the magnitude, which may be used for comparison.
2) Using current and recent historical moisture level data, the algorithm calculates the magnitude of the rate of change in moisture
3) The magnitude of the rate of change is compared by the algorithm with stored data representing maximum acceptable rate of change
4) The magnitude of the rate of change is compared with stored values for a maximum acceptable rate of change. “if” current_trend>max_acceptable_rate: energize solenoid valve
5) Alternatively “and-if” statements or other suitable code may be used by the algorithm so that data from other sensors is included in the decision to open a valve. In case the fold-angle of a turf-grass blade and the rate of change in moisture are used together, the code might read “if” current_trend>max_acceptable_rate, “and-if” blade-fold-angle<min_acceptable_fold_angle: energize solenoid valve

Reduction of image data might proceed as follows:
1) Discontinuities in a digital image are identified. These discontinuities may be points at which image brightness or color changes sharply. Mapping of discontinuities can produce boundaries that are the coordinates of the points representing the edges of a blade of grass.
2) The coordinates of the points used to represent the grass blade profile are employed by the algorithm to generate a width and a length or other geometrical data relevant to turf-grass evaluation. Once it is generated by the algorithm the geometry can be used for comparison against standards. A change in blade/leaf width may be driven by a folding of the blade about the central line of the blade/leaf. A change in blade/leaf width of more than 10% from a previously detected width, or from an ideal width referenced by the system, may result in the system ordering action or transmitting a notification or alert to a user or operator. It will be understood that percentages other than 10%, such as 8% or 15% are also contemplated.

Further, the LMC may:
incorporate one or more algorithms to calculate/measure the angle of fold of a grass blade for species with blades that may fold along an axis, and to compare this angle against a standard; and
incorporate one or more algorithms to calculate and to store data related to turf color, reflectivity, form, including cross sectional shape, blade profile, blade area and deformation, and turf uniformity, and to compare such values against standards.

An algorithm to calculate angle of fold may utilize image reduction techniques. Fold-angle changes are detectable by edge-detection algorithms. These evaluate pixels in a digital image and identify changes in pixels consistent with the edges of an object (grass-blade). The coordinates of a (folded) grass blade are used to produce a mathematical model for comparison with a standard.

In the case in which a fold-angle is being evaluated, the algorithm might:
1) determine the position (including angle) of the entire grass-blade relative to the image acquisition device (camera);
2) grass blade folding around the spine may be determined by fitting a pair of lines with a common origin at the spine to the mapped data from the camera. The angle between these two lines would be calculated, which could be interpreted as the fold angle.

Still further, the LMC may:
incorporate one or more vision systems that acquire and store images of exposed stolons, soil or other features, features that may normally be occluded by vigorous turf; and
incorporate one or more algorithms to compare exposed features against a standard.

Standards or thresholds as described herein may refer to values, shapes or image data generally recognized in the industry or in the technical literature as standard or threshold. They may be specific to a particular grass species, and the standard may vary by geographic area. Standards or thresholds as described herein may also refer to values, shapes or image data defined for LMC that does not conform to industry or technical standards or is a variation therefrom.

A landscape-maintenance controller may incorporate a database or library of images and/or geometries, which describe weeds, including dimensional information and ratios. Such information may be housed on-site or as part of the LMC device or LMC system, or may be retrieved as needed, in real time or as batch data from a remote one or more database or library of images, for example, via the Internet from a proprietary system or from a third-party information source or commercial, public or private information source.

Furthermore the LMC may:
incorporate one or more vision systems to acquire and store images of weeds; and
incorporates one or more algorithms to generate geometrical data from acquired images, and to compare this with library data.

The landscape-maintenance controller into which images and other data may be acquired or input may define the location and geometry of areas designed to be grass-free. For example, planted beds, walkways, viewing areas, sports pitch sideline areas, and the like may be designated to be grass-free. Furthermore the LMC incorporates an algorithm, which compares the stored images of areas designed to be turf free with acquired images.

The LMC may includes I/O logic to perform actions, or may control or send instruction to irrigation systems, actuators or other care systems, to open and/or close irrigation valves, to send voltage or current signals, and/or to send code to produce advisories or alerts, as a function of decisions made through optical or other comparisons with or without further correlation from sensors/transducers and seasonal data. The health of turfgrasses may be assessed by considering the following:

Blade folding: Some turf-grasses have a midvein, which may function as a spine that bisects each blade. Individual blades may open and close along the vein. Vigorous, healthy grass may appear almost completely flat, with fold-angles that appear to be 180 degrees. Fold angles in well hydrated or otherwise vigorous turf may assume other angles such as between 120 and 180 degrees or between 90 and 120 degrees. For some grass species even lower fold angles may be associated with vigorous, well-hydrated turf. As the hydration of the grass decreases, the folding of the blade can become more pronounced. Fold angles associated with very low hydration levels may be from 5 to 10 degrees or less. The grass blade may fold to very low angles with the sides appearing to touch one another under drought conditions.

Blade folding may not be uniform over the length of the blade. Grass blades do not have perfect symmetry. Also blades may be curved from the base to the tip as well as from side to side. Although the spine is the axis about which folding occurs, all grass blades would not necessarily fold in a hinge-like fashion about the axis. There may be some curling/curving as part of the folding process.

Leaf width: Leaf width may differ as a function of the maturity of an individual blade. Maturity may be determined through determination of the ratio of the width to the distance from the tip of the blade to the auricle, collar or other structures from which the blade emerges. Once maturity is estimated through this or other means, leaf width may be used as an indicator of vigor. Vigorous grass may display wider blades as compared to stressed grass.

Ground Cover: Ground cover may be measured based on surface area covered by the originally planted species. Ground cover may vary as a result of damage caused by disease, insects, weed encroachment, or environmental stress. Machine vision or 3D scanning techniques may be used to detect sparse regions by identifying stolons or other structures that are generally obscured by a vigorous grass canopy.

Leaf firing: The tips of the leaves may be yellow to brown, leaving the remainder of the blade green. Entire blades may also be yellow to brown.

Mechanical Damage: Turf-grasses should be maintained with mowing equipment having sharp blades to prevent the formation of ragged blades.

Vision systems and 3D scanning technologies may be used to acquire images. Scanned objects generate a point-cloud, which is data that identifies the spatial coordinates of discrete locations on the surface of a scanned object. The points may be used directly for comparison with baseline data or may first be converted to polygon or triangle mesh models to create a continuous surface and then compared. From blade fold angles, leaf firing, leaf-blade texture, and amount or pattern of visible soil can be used as a basis for comparison. Leaf geometry could be measured in a variety of ways to determine the foregoing. Leaf firing means that the tips of the leaves may be yellow to brown, or the entire leaf may be yellow to brown.

In addition, disclosed is a lawn care and landscaping/plant maintenance software application and web platform that builds a map of the property and the features on the property using existing data such as aerial-views from Google-Earth and also utilizes data uploaded through apps. The platform uses one or more apps and a software package to create the property map. The platform's apps utilize smart-phone GPS capabilities and/or real time kinematic surveying technology, which can make use of two GPS devices working together, communicate via radio link and using real time phase differential.

An example of how a landscape contractor may use one of the platform's apps is as follows: The landscape technician visits the exact location of an existing or newly installed plant and speaks or enters the species of the plant into the app. After verifying that the input was correct. The platform includes the information into the property map.

Another example of how a landscape-contractor may use one of the platform's apps is as follows: With the app running, the smartphone is plugged into a rolling adapter (much like the rolling wheels with extended handles used for measuring while walking). The device is rolled along the edges of plant beds and the location/path of the plant bed is recorded via GPS. The device is rolled along all grass perimeters adjacent to sidewalks, drives, roads, utility-owned devices, etc. recording all locations. The platform includes the information into the property map.

An example of how the platform's apps may be used by an irrigation contractor as follows: The irrigation technician walks along the path of the irrigation lines rolling the device along it, which records the location/path of all irrigation lines. A button is pushed on the handle that starts recording the location of spray heads. At these locations the operator specifies the type of head from the built-in library. It will be understood that non-proprietary and public libraries may be used also.

The platform also links information to one of her databases or to online resources. For instance the platform may access a built-in, proprietary plant database. The database includes maintenance information for the plant as well as general species information. When the plant species is uploaded to the platform through the app, she automatically generates a maintenance schedule for the plant and provides husbandry information. When a technician enters a species that is not in the platform's library, she has provisions for polling the internet and once the plant is verified, she adds it to the library for all users worldwide.

The platform's app may be used to add other data to the property map including for items on patios or indoor. Information may include the location and species of indoor plants, aquariums, etc.

All data from apps are uploaded to the platform. A software interface is used to access the property's account online.

The software provides a property map including locations of all plants that also includes turf. Hovering over plants causes that plant's name to be displayed. Also displayed is the maintenance information including pruning information, fertilization requirements, check for pests etc. Also displayed is the most recent information about the maintenance performed. By clicking the plant a web page is opened that provides information about the plant. Online advertising may be pushed on the pages that the system references for plant information. K-rain may choose to consider the opportunity to partner with nurseries, turf growers, landscape contractors, suppliers of soils, mulches and rock, fertilizer, etc. who may benefit from being associated with the pages that are linked to hovering over plants. Advertising would take into consideration how to provide benefits for local (such as plant nurseries), national (such as a chain of fertilizer stores that might be in only a single country) and global companies.

Also included in the property map is the location of all irrigation heads and by changing layers, the routing of the fluid lines may be viewed. Hovering over a head causes that head's identity to be displayed. Also displayed is maintenance information related to the head and if it has been replaced or received parts. Clicking on a head opens the proper page of the platform catalog. A proprietor of may want to consider the opportunity to partner with competitors that have desirable functionality to fully exploit the opportunities that might be associated with this aspect of the system's capability.

The platform provides program information a controller called “Nostromo.” Nostromo has no interface other than through the app or through information provided to the platform online. Nostromo communicates wirelessly with smart-phones and with The platform via routers.

Nostromo's irrigation fluid network may include pressure and flow sensing transducers. The platform uses this data to determine if fluid network lines are flowing normally. The platform learns what is normal and what is abnormal and establishes parameters for control. The platform sends alerts or chooses not to open valves or makes other decisions based on the integrity of the fluid lines.

Nostromo may receive data from other sensors including those that provide weather data, from moisture sensors, chlorophyll sensors, and from imaging systems with 2D or 3D capabilities and from other sensors.

The platform acquires historical and forecast data from NOAA (the National Oceonographic and Atmospheric Administration) or from other sources for rainfall, RH, wind direction and speed and solar incidence, etc. The platform also acquires data from Nostromo's transducers. The platform uses all this data to make decisions about valve opening or other tasks. The platform provides the latest irrigation schedule which is viewable online or through an app.

The platform may also send emails, text or an alert in the online system. An example of an alert from The platform is that if she learns from NOAA that a cold snap is arriving she may issue an advisory about at-risk plants and provide mitigation instructions.

Landscape maintenance personnel, irrigation companies, property owners and property maintenance companies, and technicians can access the account at different levels. For instance landscape technicians can upload information about the number of hours worked (clock-in, clock-out at different jobs), upload hours worked performing special maintenance that is not included in the monthly fee, whether irrigation heads have been replaced, fertilizing, application of other chemicals, and plant installation. The nature of work performed such as mowing, trimming, pruning, etc. would be input so that all users can understand the type and date of all maintenance performed.

The property-owner or property maintenance company interface allows for service-requests (such as if the property has to look good on a certain day). It also allows the owner/manager to understand costs by viewing information input by service companies such as maintenance, irrigation heads replaced, plants replaced or installed, etc. They can also access their invoice through the system.

The platform may generate the weekly work schedule for a landscape maintenance company by evaluating all of the accounts under contract and determining priorities. If a special service request is input to the system this is an input for deciding priorities. It may also generate additional revenue for the maintenance contractor. For instance the property owner/manager must purchase the atypical scheduling of service. The platform automatically generates and emails an invoice (from the information input by the technicians).

The platform may allow landscape maintenance companies to expand into profiting from maintenance such as roof cleaning, walk pressure washing, AC maintenance, and other property maintenance tasks. Alternatively the platform may be used by pool or other monthly-service providing companies in a fashion similar to the way she is used by landscape maintenance companies. The platform and LMC may be integrated or be provided as a single application or system. Alternatively, they, and/or components thereof, may be provided as separate applications or as executed by separate systems.

### Trend-Based Landscape Maintenance Controller

Growth trends in turf-grasses are observable. The general trend for healthy turf is for the length of grass-blades to increase until mowed, at which point the trend can start again.

A managed plot of turf-grass may exhibit other trends that may be more or less localized. Chinch-bug activity may result in a trend for turf-grass to brown and become thinner until the earth is visible. As the trend continues the patch becomes larger with a brownish, ragged edge as its border. Often the trend is for additional such patches to form in the turf.

Another example of a trend involves changes in shape or texture of turf-grass blades at various levels of hydration. As the level of hydration decreases the grass changes correspondingly. For instance some grass species produce blades with a central rib around which the sides may fold to varying degrees depending on hydration. Well-hydrated grasses appear relatively flat but these fold when they are less hydrated. Over the period of one or more days or one or more weeks, if dry conditions persist, the blades may become increasingly more folded.

The system is designed to maintain the turf as vigorous and all of its actions may be implemented accordingly. Trends are determined to allow for decisions to keep turf grass vigorous and to protect it from becoming stressed. If sufficiently stressed, turf will require a recovery period before it is once again vigorous. Depending on the degree of stress that period of recovery varies from days to weeks or even months. A task of the system is to avoid such a situation and to use trends for decision making to accomplish that goal. The system can prevent the turf from extremes of both drying and overwatering (which can stress the turf and wastes water). So the frequency of gathering data would be determined by how it contributes to turf vigor while avoiding stress.

In general turf does not transition from fully hydrated to dehydrated over the course of a single day (although there may be exceptions). For, example, for St. Augustine cultivars in Florida, the minimum watering cycle during hot-dry periods in summer may be twice per week to avoid permanent damage. Trend determination could therefore be seen as a means to ensure that stress does not occur over a half-week in summer. Trends evaluated may include the trend in the magnitude of the hydration level of the soil as provided by a moisture sensor or a trend in geometry change such as in the reduction of fold-angle about a central spine (or other grass-blade profile changes). These trend-lines may take many forms and are unlikely to be linear. Therefore it may be advantageous to sample more often when trends indicate that stress is imminent.

The frequency of sampling depends on what is most useful for the system in terms of contributing to its effectiveness at making decisions on when valves are energized. The frequency of sampling may change over time since initially the system may need to sample more frequently so that it can learn which conditions are consistent with the need to irrigate.

The system may make better decisions by using its own database of fold-angles as a function of hydration rather than relying on a built-in database. For example, the system may be connected to a central website linked to a database, which may be composed of servers storing information online, and acceptable by other systems. In this way, each site of lawn maintenance need not have its own database and, accordingly, each system's task may be simplified. Thus, each lawn care facility may use the same central information as appropriate for its turf cultivar. It may be advantageous for the system to build a database that looks at sensor data numerous times over the course of the day so that it understands how parameters change over 24 hours. In like fashion, it may be advantageous for the system to understand how parameters change seasonally (over the course of a year). Some daily or seasonal sensor data might indicate that irrigation is needed (when it actually might not be) if it is not normalized to account for the impact of the time of day or season.

A further example of a trend involves changes in turf-grass color. The color of grass may change from green to yellow to tan or brown. The blades of grass do not typically change from one color to another instantaneously but rather the changes are gradual.

Growth trends in turf-grasses may be observable. A general trend for healthy turf is for the length of grass-blades to increase until mowed, and then the growth trend starts again.

A managed plot of turf-grass may exhibit various trends, which may be more or less localized within a given turf. Chinch-bug activity may result in a trend for turf-grass to brown and to become thinner until the earth is visible. As this trend continues, the patch can become larger with a brownish, ragged edge as its border. Often the trend is for additional such patches to form in the turf.

Another example of a trend is a change in shape or texture of turf-grass blades at various levels of hydration. As the level of hydration decreases, the grass changes correspondingly. For example, some grass species produce blades with a central rib, around which the sides may fold to varying degrees depending on hydration. Well-hydrated grasses appear relatively flat but they fold when they are less well hydrated. Over a period of one or more days, or one or more weeks, if dry conditions persist, then blades may become increasingly folded.

A further example of a trend is a change in turf-grass color. The color of grasses may change from green to yellow to tan to brown as conditions deteriorate. The grasses do not typically change from one color to another color instantaneously but rather the changes are gradual.

Hydration levels that are higher than optimal and hydration levels that are lower than optimal may produce color changes. Relatively high and low hydration levels may produce similar coloration divergences compared to vigorous turf. For instance, a higher than optimal level of hydration may result in yellowing of the turf and a lower than optimal level of hydration may also result in yellowing.

Grasses may display differing coloration from species to species, from season to season, after application of nutrients including minerals, and from other comparative aspects. Coloration that is indicative of vigorous turf.

Color may be defined as visual perception among humans to red, blue, yellow, green and others. Light striking the earth or objects from the sun or from artificial sources is either absorbed or reflected. The reflected portion striking the eye produces the phenomenon of color perception. Non-visible light, such as infrared, may also be detected and used to determine trends.

An optimized landscape maintenance controller will recognize divergences from the color of vigorous turf, which could include infrared and take corrective actions. For the landscape maintenance controller to evaluate turf (or other plant) vigor based on color, it may utilize baseline data for comparisons. This baseline data may come from a library, or it may be learned/acquired, or from a combination of these. For example, deviation of 15% or more from the baseline, or from the standard, may be deemed to be actionable. However, it will be understood that greater or smaller deviations may also be or instead be actionable, and that the threshold against which deviation is measured may be an absolute value, such as a fixed value of turf color, or average turf color, beyond which action is to be taken. An actionable change or deviation may entail the generation and transmission of a notification to an operator or owner of the property and/or taking automated action such as opening an irrigation valve for an area, commanding a lawn mower start or lawn mower delay, or some other action.

The system could also “expect” that the turf to be a certain color, perhaps as a function of season, hydration, and temperature (and maybe other factors) and if the color is different for what is expected, then the system could take action. For example, temperature just above the ground, for example, up to 1-2 inches above ground level, should be cooler than ambient air temperature. This is because, if the soil in which the plants grow is well irrigated, evaporation of moisture from the ground will tend to cool the air in the immediate vicinity. Such temperature may be measured by a thermometer or sensor positioned in the ground with the sensing portion rising just above the ground, or in any other suitable way. Ambient air temperature may be measured by a stationary sensor, by a portable device such as a handheld digital assistant or communication device, a lawncare equipment-based sensor, or other mobile sensor, or may be based on information received (for example, over a data network) from an outside weather data source, or the like. If no difference between the near ground temperature and the ambient air temperature is detected, then the system may determine a lack of sufficient irrigation and instruct action. Conversely, too much watering may be diagnosed if the air temperature gradient is substantial, for example, consistently more than 2-3 degrees. Alternatively, if a tend in air temperature gradient readings indicates a significant decrease over time, then this too may be sufficient to instruct action. Such an action might include alerting personnel that the color is indicative of a problem and asking them whether they concur on a course of action. In this way the system could learn.

Learning could proceed through interaction with such an operator. For instance, the landscape controller may advise the operator that it plans to irrigate. The operator then may input to the controller not to take this action. Or conversely the operator may order the controller to irrigate when the controller had not planned to do so. In either case the controller learn what constitutes a trend that justifies opening a valve or that justifies some other action.

Another example of a trend is that the hydration level of the soil and the corresponding evapo-transpiration that depletes the water in the soil. The trend could be of soil progressing toward a greater or lesser state of hydration. The evapo-transpiration could increase or decrease over time. Accordingly, a controller of the system can evaluate and make a decision about environmental trends associated with a turf. If a trend for hydration depletion continues, the system can make a decision to irrigate or to increase irrigation, or to increase frequency of irrigation, of the turf as a whole, or of a particular spot of the turf if the trend is a local trend within the turf.

If a lawnmower is making ruts in the turf and if the next week those ruts are bigger. The width and depth of ruts depends on the equipment that is being used to maintain turf and probably on the species of turf being maintained. Ruts may be produced by relatively small and light equipment but more pronounced rutting occurs more quickly from heavier equipment. The ruts are produced in the same fashion as any other path; through the wear associated with traffic.

By way of example, a landscape maintenance controller may recognize ruts based on the appearance of stripes in the turf. The appearance of the ruts could be detected, for example, by one or more cameras that provide images to Landscape Controller 20. Such cameras could also provide images based on which plant color and/or plant shape/texture is determined by plat color module 35 and plant shape/texture module 36. For example, deviation of 15% or more from the baseline, or from the standard, may be deemed to be actionable.

If stripes are persistent, it may be indicative of a trend. Identification of a trend in striping that persists for a period spanning weeks or months may be cause to alert personnel that mowing patterns need to be varied. The system could notice increased size of the ruts and takes some sort of action, for example, send a message to a human operator, or open a valve or the like.

The controller can utilize trend information to make decisions to open valves, or to increase the opening of valves, or to increase frequency of irrigation, or to make other decisions related to the maintenance of turf-grasses. Periodically, information can be sampled and/or recorded related to turf-grass, including color, fold-angle, patchiness, texture, blade length, soil hydration levels, ground temperature, turf temperature, etc. and trends can be noted. Based on these trends, hydration levels can be assessed, and irrigation and other maintenance decisions can be made accordingly. More than one such trend can be kept track of to make a decision as to hydration or as to overall health of the turf, or a portion of the turf, and decisions can be made accordingly about maintenance, including irrigation and the like.

Multiple trends can be used to make decisions to open valves, or to increase the opening of valves, or to increase the frequency of opening of valves, or to make other decisions related to the maintenance of turf-grasses. For instance, the system may evaluate the trend of soil hydration, and also evaluate the trend in soil or turf temperature, and make a decision based on both trends. Evaluation of trends and of multiple trends allows the controller to make better decisions. Decisions based on a single data point can be out of sync with turf-grass or ornamental plant requirements. For example, a sensor or transducer may provide a data point that does not represent actual conditions. This may occur due to the presence of a water droplet on a transducer or other anomaly, and this will cause transmission of a data point that does not reflect actual conditions.

The time of day may influence the amount of folding of a grass blade. Relatively dehydrated grass may be at a wide-open state in the early morning hours and then quickly fold as the sun rises. Therefore it is not only the folding that may be used to make decisions about irrigation, but folding as a function of the time of day and/or the solar incidence. The rate of the folding may also be used as an input for decisions. For example, a folding rate increase of 15% or more per day may indicate an unacceptable rate increase, which may require generating a notification and taking action, such opening an irrigation valve for the area.

Fold angle could be time of day dependent. For instance in the morning, when dew is present and the turf may appear relatively more hydrated. A (short) time later such dew may evaporate and the fold angle (or other form-factor) may change as a result. For this reason the software may look at the “trend in trends,” or a trend in first order derivatives, or how the trend changes from one day to the next.

The system could use the input from various sensors to learn what the correlation between fold-angle and hydration level is. The system could also learn that other geometry changes besides fold angle occur, such as curling, bending, drooping, crenating, shriveling, or shrinking.

Also, initially the system may start operation with no threshold data; the system could store data and thresholds may be generated and stored. An example of how this might work is as follows: Over the course of the day the system regularly determines fold-angle (or determines other blade geometry) and also regularly determines the hydration level of the soil and solar incidence from sensor input. The system also keeps track of irrigation history. These four factors are correlated so that the system “understands” the relationship between them.

Any factor, if taken by itself might trigger a solenoid to be energized when irrigation was not needed. But if several factors are considered together the odds increase that irrigation decisions are correct.

During the initial stages, or during periods when atypical changes are occurring, human-input might serve to “teach” the learning system. At such times the system may request input from the operator. For instance on the first day of operation, the system may alert the operator that it will energize a solenoid valve the next morning unless directed to do otherwise. The operator may tell the system not to take this action. The system can use this information along with data from sensors and learn that under the present set of conditions, energizing of a solenoid is not called for. Likewise when the operator tells the system to irrigate, the system learns under what set of conditions and trends that energizing a solenoid is called for. The system stores both trend (historical) and instantaneous information and also calls for and makes use of operator input. Over time the system requires less operator input since it has learned when it is appropriate to energize a solenoid valve.

The present disclosure includes a turf-grass irrigation/maintenance controller that utilizes trend information of one or more of the types of trends discussed herein to make decisions about landscape maintenance. Such decisions include opening valves, issuing alerts, or other decisions related to the maintenance of turf-grasses. The system includes a means for periodically recording information related to the turf-grass including color, fold-angle, patchiness, texture, blade length, soil hydration levels, ground temperature, turf temperature, etc. The information is then evaluated to identify any trends. These trends are used by the controller to make decisions.

A blade's maturity can be determined by measuring ratios of length to width of blades of grass within a turf-grass plot, and then the vigor or health of the grass can be evaluated as a function of the blade width in view of the blade maturity. This can be done using angles of turf grasses compared with optimal or average fold angles obtained from plant libraries or image libraries, as discussed below. If over a period of time, the change in fold angles of the turf-grass blades trends to indicate greater dehydration or greater hydration, decisions can be made about whether to open valves or take other actions.

Maturity could be determined to compare a particular variety of grass of maturity level X only to reference graph data of the same variety and maturity level X. That is, the fold angle could be cultivar-specific. Further, the fold angle threshold at which irrigation is triggered could also be maturity-level specific as well as cultivar-specific.

It may be undesirable to make irrigation decisions based on the geometry of immature grass blades. For species with a central vein or spine the immature blade may emerge in a folded state and then unfold as it matures. If such a folded, immature blade is used by the algorithm for decision making, its fold could be interpreted by the software as a function of low hydration and a decision to energize a valve might be initiated. Therefore for some species such as St.

Augustine cultivars, it may be advantageous to first determine blade maturity so that blade fold angle may be related to the level of hydration.

The present disclosure is for a turf-grass irrigation/maintenance controller that can utilize one trend or multiple trends to make decisions to open valves or to make other decisions related to the maintenance of turf-grasses. For instance the system may evaluate the trend of soil hydration and evaluate the trend in soil or turf temperature and make a decisions based on both trends.

Evaluation of trends and of multiple trends allows the controller to make better decisions. Decisions based on a single data point can be out of sync with turf-grass or ornamental plant requirements. For instance a sensor or transducer may provide a data point that does not represent actual conditions. This may occur due to the presence of a water droplet on a transducer or other anomaly that does not represent true conditions.

The system may flag the operator and the human operator could take action. The system could learn from the actions taken by the operator to take some similar action when a future analogous scenario arises or to refrain from taking action under such conditions.

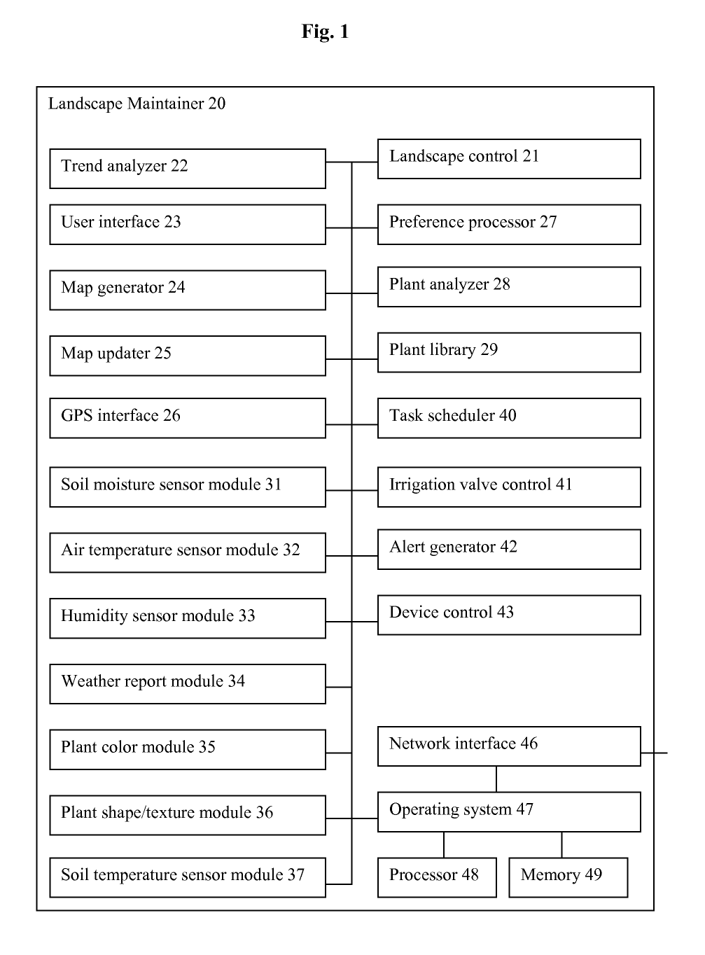

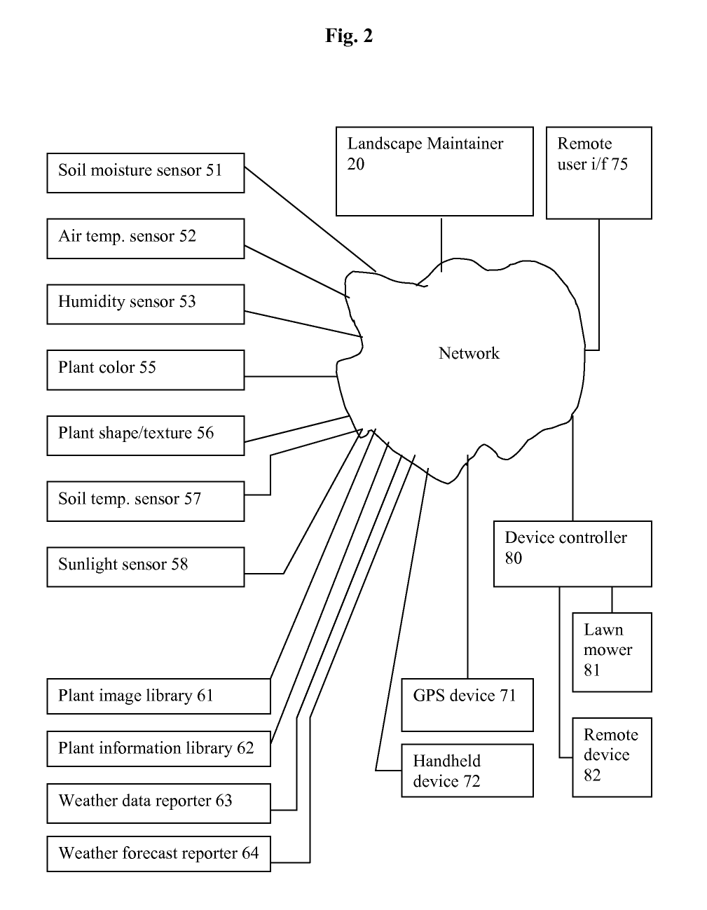

An example of this trend-oriented control system will now be described with reference to FIGS. 1 and 2. Landscape maintainer 20 may be a computer or a module of a computer or other type of processor including a laptop, a handheld device, a smartphone, a remote server or other type of device.

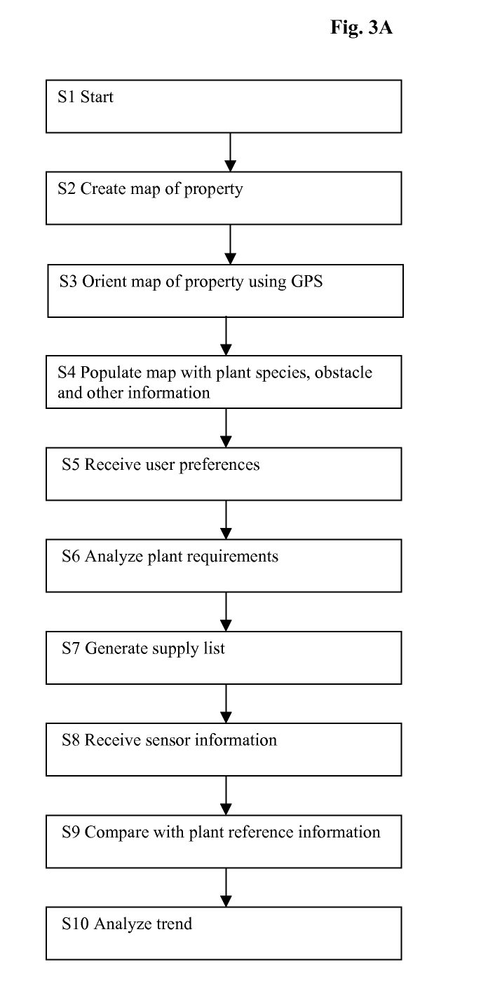

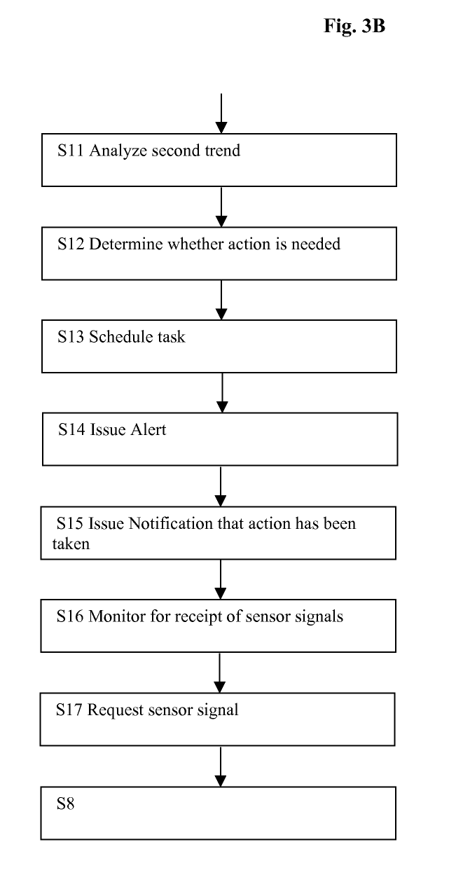

A user or a landscape technician can start by creating a map of a property to be maintained by entering data via network interface 46 to map generator 24 of landscape maintainer 20 illustrated in FIG. 1. An example of an operation of the system is illustrated in FIG. 3.

Landscape maintainer 20 may be provided as a computer or as more than one computer working in tandem on site or off site and run by operating system 47 using microprocessor 48, or several such microprocessors, and memory 49, which may be implemented as RAM, ROM, or more than one such memory device. Overall control of the landscaping maintenance application may be provided by landscape control 21. GPS interface 26 may be used to generate, to orient, and/or to populate the map. For example, GPS device 71 may provide GPS information to landscape maintainer 20 or landscape maintainer 20 may itself include a GPS device or it may receive GPS information from another device via network interface 46 or by other means. Using user interface 23, the user can enter the location of various landmarks on the map, including garden plots, lawn boundaries, irrigation heads, irrigation valves, pathways, driveways, lawnmower and lawn care device locations, lawnmower and lawn care device charging locations, and the like.

An operator can input grass strain under cultivation and/or of weed strains to anticipate. The operator may input the strain of grass into landscape maintainer 20 so that the comparison process is simplified and therefore has greater immunity from errors. For instance if the operator inputs (or selects for a library) that the species being tended is a St. Augustine cultivar then the turf will thereafter be compared with data from the library for that general type of turf (St. Augustine Cultivars). Furthermore the operator can input that the “Floratam” or the “Captiva” strain is under cultivation. In that way the turf will be compared with the data for that specific cultivar (St. Augustine Cultivars, Floratam) or (St. Augustine Cultivars, Captiva). In this way the comparison process employed by an algorithm is further eased providing further immunity from errors. In a similar way the landscape maintainer 20 can reference a library of endemic weed species so that when an attempt is made to acquire weed characteristics the number of species to be compared is minimized. Updating the map is possible using map updater 25 by interacting via user interface 23 with Landscape maintainer 20.

Based on the plant type information that is entered in the map for a given area of the map, and the location of the area, and also the other landscape features of the zone, such as walkways, plant beds, trees, lamp posts, driveways or the like, a list of irrigation hardware that is required or recommended or needed for the plant may be automatically generated. Such irrigation hardware may include spray, drip and other nozzle types, valves' pipes fittings, as well as their sizes, capacities, length or the like. In addition to irrigation equipment, mowing, trimming and other such landscaping equipment, as well as their sizes, capacities and types may also be recommended. For example, the computer that receives the plant information and the other features of the landscape information for the map may include a lookup table providing correspondence between types of plants and their irrigation needs, as well as length of irrigation pipes, hoses and the like, the size and configuration of areas that can be covered or irrigated by irrigation sprays or nozzles, or the like. In accordance with the foregoing, an irrigation schedule may also be generated on an area-by-area basis for the zone in view of the data received. For example,

If “Adjacent to Sidewalk” is true

And-if “turf” is true

And-if “plant-bed” is false

And-if “Adjacent to only a single Sidewalk” is true

And-if “Turf Width”>=to 15 feet

And-if “Plant Bed Proximity”>=to 15 feet

Increment hardware count of 15 foot 180 degree or adjustable nozzles by 1 (increment hardware count of specific nozzle or set of nozzles).

Similar statements could be employed throughout the code and ideally none of it would require the input of anything other than the elements of the landscape such as drives, walks, turf, foliage, plant-beds, etc.

Landscape control 21 receives various types of information about the property and its environment from a variety of sensors and/or from information manually input via user interface 23 to Landscape maintainer 20. Various sensors may be positioned in and around the property and may communicate with landscape maintainer 20 via a direct wireless connection, communicating over Bluetooth, shortwave radio frequency or other types of radio frequencies, infrared communication satellite link, a wired connection, or may use an intermediary device, such as a wireless router to communicate with landscape maintainer 20.

Illustrated in FIG. 2 is a system diagram showing Landscape maintainer 20 communicating via a cloud with sensors 51-58 to obtain information about one or more portions of the target region or the target region as a whole. FIG. 2 illustrates a soil moisture sensor 51, an air temperature sensor 52, a humidity sensor 53, a plant color sensor 55, a plant shape texture sensor 56, a soil temperature sensor 57 and a sunlight sensor 58. Sunlight sensor 58 detects an amount of sunlight. Each of these sensors 51 and 58 signal information detected to corresponds to modules of Landscape maintainer 20. While sensor 51 and 58 and other elements of the system are shown to be in communication with Landscape maintainer 20 via the Internet, such that each of the sensors 51-58 and the other elements of the system have a unique MAC address and communicate via Landscape maintainer 20 using Internet protocol, it will be understood that other types of communication with Landscape maintainer 20 are also envisioned, for example, Bluetooth, short range or other radiowave communication, infrared communication, physical connection, such as via USB, Ethernet or HDMI, coaxial cable connection, or the like. One or more of the elements shown in FIG. 2 may communicate with landscape maintainer 20 using a different medium of communication than other elements of the system.

Such sensors 51-58 may communicate with soil moisture module 31, which processes signals reporting soil moisture, soil temperature sensor module 37, which processes signals reporting the temperature of the soil, air temperature module 32, which receives air temperature signals based on readings taken by air temperature sensor 52, which detects the temperature of the air at the property, humidity sensor module 33, which processes signals reporting humidity of the air at the property, plant color module 35, which receives information about the color of one or more plant or plant areas, such as a lawn area, of the property, for example, using camera and plant-shape, and/or texture module 36, which receives information about the shape and texture of one or more plants, the contour of one or more garden, flower or lawn beds or the like. Plant color module 35 and plant shape and/or texture module 36 may receive reports from cameras stationed or removable at the property. One or more cameras and other sensors, including temperature sensors, humidity sensors and the like, may be handheld, positioned on or provided as part of various types of equipment, including plant and lawn maintenance equipment, positioned on roofs, poles, or on other fixed structures, or the like. Soil temperature and soil humidity sensors could be stand-alone devices positioned in the soil or in several soil area and/or could be provided in other ways.

For example, a camera providing a top view may photograph or take images of an area of a lawn to determine an overall color thereof, shape/texture of plants, pattern of lawn coloration, pattern of lawn degradation, rut or rut pattern or the like, and changes in the foregoing. Similarly, one or more cameras may be positioned above an area to photograph or to capture images of a lawn area to determine shape or texture of blades of grass and/or the amount of folding of blades of grass with respect to a central rib, or to obtain the other types of data discussed herein. Plant color module 35 may also receive signaling from sunlight sensor 58 about the amount of sunlight detected. Introduced marks and patterns in turf which are persistent are generally undesirable. These may take the form of a single stripe or as a series of stripes or could appear as a checkerboard effect or other. Marks and patterns may be most evident immediately following mowing and fade as the grasses rebound after being compacted and as the grass grows. Rutting and other wear in turf grasses may occur due to tires of maintenance machinery traffic. These effects may occur over a relatively long period of time or a relatively short period of time. Such wear may occur at a greater rate if equipment is driven over turf with a high soil moisture level, if tire pressure is excessively high, due to aggressive tire treads, and when tires spin or slide. An introduced mark or pattern that persists may be due to soil compaction, compaction of stolons or other turf-grass structures, or due to turf-grass density reduction which also may be termed thinning. Persistence may be recognized by comparing sequentially acquired images.

A landscape maintenance controller that recognizes persistent marks and/or patterns and which takes actions to reduce or eliminate persistent marks and/or patterns is superior to controllers which do not recognize and take corrective actions. Actions which may be taken by the LMC include alerting maintenance personnel that the problem exists. The LMC may also reprogram robotic or automated equipment so that their path of travel over the turf is modified. The width and depth of ruts depends on the equipment that is being used to maintain turf and the species of turf being maintained. Ruts may be produced by relatively small and light equipment but more pronounced rutting occurs more quickly from heavier equipment. The ruts are produced in the same fashion as any other path; through the wear associated with traffic. A landscape maintenance controller may recognize ruts by the appearance of stripes in the turf. Persistent stripes may be indicative of a trend. Identification of a striping trend that persists for a period spanning weeks or months may be cause the system to alert personnel that mowing patterns need to be varied, that tire pressures need to be adjusted, and the like. Identification of persistent marks and patterns may be accomplished using machine vision techniques.

Each image may have associated with it two weighting factors. The first weighting factor may be associated with the elapsed time since mowing occurs. Images that identify marks, such as a stripe, that are acquired immediately after mowing may be assigned a lower weighting factor such as 0.1 while an image which identifies a mark such as a stripe that are acquired five days after mowing may be assigned a weighting factor of 1.0. According to an implementation, lower weighting factors are assigned to images temporally near the mowing event because marks and patterns are common immediately following mowing and these are likely to rebound from compaction. Higher weighting factors are assigned to images temporally distant from the mowing event because marks and patterns fade due to rebounding from compaction and due to growth. Thus, the marks and patterns that present when these are distant from the mowing event are more likely to be persistent in nature. The second weighting factor may be associated with the intensity of the mark or pattern. Intensity may be judged in several ways, including tone (color) and intensity. The mark or pattern detected by the system in a captured image may be compared against an internal library or against an external database. The second weighting factor may be assigned a weighting factor of between 1.0 and 10.0. In such a case a weighting factor of 1.0 may be associated with a relatively diffuse mark or pattern while a weighting factor of 10.0 may be associated with a relatively more pronounced mark or pattern. If some predefined number of images, for example, five images of a plot of turf grass are acquired at a rate of one per day, and if a mark or pattern is identified on each day and if the first and second weighting factors are multiplied, over a prescribed period of time all of the multiplied factors may be summed to produce a decision factor. If the decision factor is low the LMC may take no corrective actions. If the decision factor is high the LMC may issue alerts, it may act to reprogram automated equipment or to take other action. Weighting factors other than those described may also be employed. The first weighting factor may be between values that are different than 0.1-1.0 and the second weighting factor may be between values that are different than 1.0-10.0. Also the generation of a decision factor may occur through means other than the combination of multiplication and summation as described. Additional factors may also be included in the assignment of a decision factor. These factors may include season, temperature, rainfall, soil moisture level, the relative hydration level of the turf or other factors.

Machine Vision or 3D scanning techniques may be used to detect the density or sparseness of regions of vegetation. The system may also prompt a user to photograph or scan one or more leaves or blades of grass to obtain information about color, texture, firmness, dryness and degree of bending or the like. It will be understood that more than one of each of these sensors may be positioned at the property at various locations, at various heights, and at various angles depending on the information sought to be retrieved. Sensors 51 and 58 may be stationary or movable pursuant to Landscape maintainer 20 command, or may be movable by a user as needed, or as instructed by Landscape maintainer 20. For example, user may have a handheld device, such as a smartphone with a camera, that takes pictures of a lawn, patches of a lawn or individual blades of grass to determine color, texture, shape, fold angle and the like. Similarly, the handheld device carried by user may report temperature data, weather data and the like, and the user may key in other information that the user reads from stationary sensors or that the handheld device automatically receives from stationary sensors. In addition, the reporting of signals transmitted from each of these sensors may be performed automatically on a periodic basis, or upon request of Landscape maintainer 20.

FIG. 2 also illustrates remote user interface 75 and handheld device 72 which can communicate with landscape maintainer 20. For example, handheld device 72 may be a portable device, such as a smartphone that a person caring for the property uses to communicate with Landscape maintainer 20 to input data, such as sensor readings, to enter plans, such as grass, or weeds or other unwanted or undesirable plants or to enter hazards for lawnmower 81, such as gravel or rocks or other obstacles to landscape maintainer 20. Landscape maintainer 20 issues alerts or other notifications or instructions to handheld device 72 and/or to remote user interface 75. For example, remote user interface 75 may be a desk or a laptop computer, a handheld device or the like. Landscape maintainer 20 may also include or be comprised as a server computer that requests and receives readings from one or more of sensors 51-58 and that provides commands to irrigation heads and other remote devices. Device controller 80 communicates with Landscape maintainer 20 via a cloud or via other pathways and controls lawnmower 81, irrigation heads or other types of remote devices. For example, device controller 80 may be or may include a wireless router providing commands to lawnmower 81 and/remote device 82. GPS device 71 may be integrated with handheld device 72 or maybe a separate device that allows the user to generate a map of a property, to orient the map of the property, to scale or size the map of the property and/or populate the map of the property with the various kinds of plants, the contours of lawns, the position of obstacles, such as trees, telephone poles and rocks and the like, the position of roads and paths and the like.

Plant image library 61 and plant information library 62 may be one or more libraries located off site or on site, or may be commercial databases provided by a third party. Weather data reporter 63 and weather forecast reporter 64 may be positioned on site or off site, or may be commercial sites provided by servers operated by a third party. Alternatively, plant image library 61, plant information library 62, weather data reporter 63 and weather forecast reporter 64 may be proprietary systems run by the owner or operator of a landscape company or by the owner or user of the property. It is understood that one or more elements shown as separate systems, sensors or devices may be integrated, or may be formed of more than one unit.

In addition, weather report module 34 can provide historical data about weather conditions for the area in which the property is located or can provide forecasts of the weather for the area of the property by using one or more commercially available weather databases or news channels.

Landscape control 21 receives this information and trend analyzer 22 can detect trends in soil moisture at one or more locations of the property being monitored, soil temperature, air temperature, humidity, plant color, plant shape, of patches of the lawn at the property for the property as a whole. For example, the degree of folding about a central rib of the sides of a blade of grass, the contour of a lawn, the coloration of a lawn and the like may be processed at two or more times to generate a trend.

Trends can be used to make decisions. For instance, action could be taken as a result of progressive changes in turf-grass blades. If on day 1 the blade is folded to 150 degrees, then if on day 2 it is folded to 900, and then on day 3 it is folded to 45°, then the trend indicates that irrigation is needed. This may be true even if the folding at 45° is determined to lie within an acceptable range.

In addition, landscape control 21 can determine, diagnose or forecast likely conditions of a plant or a garden, or lawn or the like at the property based on the trends detected. For example, as discussed, a trend of yellowing or browning of the color of an overall lawn, or the changing of a lawn color from green of an area of a lawn can be indicative of a drought condition at the property as a whole, at the lawn section as a whole, or at a particular patch of the lawn. In addition, plant library 29 may include information about various types of plants and grasses, including reference images of what a healthy plant or a healthy lawn may look like. For example, a user may enter on the map via map updater 25 the name or other identification of various types of plants, including grasses to be found on the property, and then plant library 29 can be consulted by landscape control 21 to determine whether, based on the sensor data for the plant or the lawn, the plant or the lawn is within normal parameters, optimal parameters, sub-optimal parameters, unacceptable parameters or the like. That is, landscape control 21 can compare the current condition of a plant or a lawn or the like with reference data contained in plant library 29, for example, can compare images for color information or folding ranges of blades of grass, to determine whether current conditions at the property fall within an optimal range, sub-optimal range, acceptable range or unacceptable conditions. A stationary positioned, handheld or lawncare equipment-attached camera can capture visible light at a first time and at a second time and that a percentage change, or a change in absolute value, of the wavelength of visible light for the grass captured by the camera can be found. Visible light has wave-lengths from 390 to 700 nanometers. A color standardizing system, for example, according to the CMYK process using four colors, cyan, magenta, yellow, and black, may be used. A Pantone color matching system may be used, according to which colors are standardized in this way. Further, an RGB model may be used to represent and to study color. In this model, the three primary colors red, green and blue are mixed in various proportions to generate other colors. For instance, red and green may be mixed to produce yellow. Other models which use different sets of primary colors exist and these models are similarly capable of generating large numbers of colors through mixing. A Munsell color system or hexadecimal triplets may be used in addition to or instead of the foregoing. Colors may be represented numerically. The wavelength of reflected light may be determined and the associated colors may be assigned numerical values. Thus a mathematical model of color may be constructed.

Color may vary from species to species of turf grasses. The color may also vary seasonally, and due to other factors. The color of turf grasses are associated with vigor. The color of vigorous turf may be described over a range of colors rather than discretely. Turf grasses may be expected to reflect portions of the visible spectrum with wavelengths between 490 to 575 nanometers or to reflect portions of the visible spectrum which when combined approximate the appearance of wavelengths within that spectrum. Numerical databases exist or may be constructed which correlate vigor with color. These databases may be compared with acquired turf color data. A visible light wavelength cutoff or quantitative threshold may be used, such that when the color of the graph has a wavelength higher than the threshold, some action will be taken. Light color data may be compared to a reference image in which a visible light wavelength cutoff or quantitative threshold may be used, such that when a color of the photograph (wavelength of light) goes above or below a threshold based on the reference image, as may be appropriate, some action will be taken. The threshold may be based on the standardized colors of the Pantone matching system, for example, or any other standardized system. If the acquired color data is determined to be a best match to an acceptable color range, or standard reference color for a cultivar, then the system can determine that no action is required. If the acquired color data is determined to fall outside of that range, then action will be initiated. Alternatively, a marginal deviation from the acceptable color range may be deemed by the system to non-actionable and will result in no immediate action, or may result only in the transmission of a notification to a user or operator.

The color of grass may be recorded over time based on captured images of the turf. A trend is produced as grass color changes. Acquired trends may be compared with library trends. An example of a library trend is numerical data consistent with turf grass progressing toward being relatively more green or yellow. If a trend is identified that is consistent with a decrease in turf vigor, the Landscape Maintenance Controller is programmed to take one or more corrective actions. According to the trend-based decision approach, a steepness of the rate of change over some (potentially exponential) part of the trend's curve may indicate an actionable change. For instance, if the slope of the tangent to the trend line exceeds 30 degrees at time x, for example, on day one, and then if at time x+t, for example on day two, the slope of the tangent to the trend line significantly differs from that slope, then this may trigger action. If over the course of some period, for example, over five days, the slope of the tangent to the trend line changes by more than a certain rate, then action would be called for. It will be understood that other time ranges are also contemplated for determining action. According to an aspect of the trend-based approach, the image data based on which captured color data is generated may be captured at the same time every day, so that diurnal variations can be controlled for. Similarly, other sensor readings, such as the temperature of the air near the soil and other temperature readings, fold angles and blade widths and other factors identified, may be take at or nearly at the same time every day, or at a predetermined time after or before sunrise, dusk, noon, etc. Accordingly, landscape control 21 can take actions as described.

Preference processor 27 can receive, via user interface 23 from the user, preferences for the minimum and/or maximum quantities of water that can or should be used for the property as a whole or for various portions of the property, for example, for a particular lawn area, whether sprinkling is permitted at various times of the day, various times of the week, or various times of the season, whether an automated robotic lawn care device, such as an automated lawnmower, is available, and the like.

Accordingly, landscape control 21 can set a task in task schedule 40 in accordance with the trend found and in accordance with preferences entered by the user. For example, landscape control 21 can set a task in task schedule 40 that irrigation valve control 41 will open to a certain predefined extent to allow a particular quantity of water per time unit, such as half gallon per minute, to be released by irrigation head A in patch B of lawn area 1 of the property. In addition, a task may also be set to activate an automated lawnmower by device controller 43 controlling the lawnmower to proceed to a particular area of the property and can set the tasks to be performed by the lawnmower.

The user may also request that alerts be provided upon the detection of various conditions or upon the occurrence of various events using alert generator 42. For example, alert generator 42 can generate an alert anytime landscape control 21 determines an abnormal or sub-optimal condition at the property, anytime a task schedule 40 is updated, anytime the irrigation is set or changed or allowed to proceed, or the like. Such alerts can be sent to an owner, a user or a dweller at the property, and/or may to a person or a company responsible for landscaping or caring for the property. The user can also be notified that an action, such as the opening of an irrigation valve, has been taken. The user may be allowed to set in preference processor 27 user preferences for receiving such notifications and such alerts. Alert notifications may be provided as SMS texts, e-mail, voicemail as updates on a website or the like.

An operation of landscape maintainer 20 according to an aspect of the present disclosure will now be provided with reference to FIG. 3. At S1, a system is started, for example, a user may wish to create a new map for a property to be maintained. It will be understood that one or more of the steps provided may be optional and that additional steps not illustrated may also be included in the method. At S2, a map of the property to be taken care of is created or retrieved from a third-party source and uploaded. At S3, the map can be oriented using GPS information. S4 describes that specific plant information and obstacle information can be populated to the map. For example, the various areas of the property, including the location of lawn areas, the location of gravelly or sandy areas not taken care of, the location of trees, rocks, driveways and other obstacles for lawn mowing equipment, the location of other areas for which irrigation is to be avoided, such as a children's playground or buildings, vegetable patches, flower beds and the like, can be added to or indicated on the map. At S5, user preference information for frequency of irrigation, permissible water usage, whether the grass is to be maintained at an optimal state, such as for a golf course, or in a healthy but suboptimal state, for example, for a larger area not actively used, the frequency of alerts and notifications to the user, the availability of lawnmowers, including automated lawnmowers and other landscaping equipment, and the like.

At S16, landscape maintainer 20 receives sensor information from one or more of sensors 51-58. This information is processed at landscape control 21 of landscape maintainer 20 by referring to one or more of modules 31-37 as described above. The received sensor information is then processed by plant analyzer 28, which can create a profile of the plant, including grass maturity, the season of the year and the like. This information can then be compared with information retrieved from plant library 29. Further, trend analyzer 22 at S16 compares a trend for the plant by analyzing data received at two or more points in time for the plant. A second and third trend can also be analyzed by trend analyzer 22, as shown at S15. A determination is then made by landscaper control 21 according to preference processor 27 information as to whether action is to be taken based on the detected trend. At S15, a task can be scheduled to task schedule 40 to take action, such as to activate irrigation valve using irrigation valve control 41 or by controlling another device using device control 43. At S16, an alert can be issued to the user according to the task scheduled at task scheduler 40. An alert can specify a task, such as irrigation of one or more areas, to be performed by the user. An alert can also inform the user that a task, for example, irrigating the lawn, is scheduled to be performed, and may also indicate the area of the property at which the task is to be performed and its timing. In this way, user can override the scheduled task and prevent it from occurring or modify when, where or how it is performed. For example, the user may cancel a scheduled automated sprinkling of the laws if the user is confident, for example based on a weather forecast that it will soon rain.

At S15, one or more irrigation valves can be activated, and at S16, one or more devices, such as a lawnmower, can be activated. At S17, notification can be sent to a user notifying of the action taken. At S16, the system monitors for additional signals received from the sensors. Further, at S17, a request can be issued to one or more of the sensors to transmit sensor reports. This is dependent on whether the sensors are set to automatically push signals indicating their state or are set to respond only when a signal is requested by landscape maintainer 20. The system can then return to S16.

Disclosed are a method, system, module, means for performing a method, and a computer-readable medium incorporating a program of instructions for executing a method. The system, module, and computer readable medium incorporate instructions to perform a method as outlined herein and as illustrated in FIGS. 3A-B. The means for provide the functionality described herein according to a structure as described here and as illustrated in FIGS. 1 and 2. The methods and functions can be performed entirely automatically through machine operations, but need not be entirely performed by machines. Similarly, the systems and computer-readable media may be implemented entirely automatically through machine operations but need not be so. A computer system may include one or more processors in one or more units for performing the system according to the present disclosure and these computers or processors may be located in a cloud or may be provided in a local enterprise setting or off premises at a third party contractor, and may communicate with a user requesting an assessment of a turf or grass area or requesting the system to take decisions thereon and possibly to also control irrigation and other lawn care actuator mechanisms and controls on site via a wired or wireless connection, such a through a LAN or WAN, or off site via internet protocol-enabled communication, via a cellular telephone provider or via other such means. Similarly, the information stored and/or the patent database from which the sets of data are extracted, may be stored in a cloud, in an official or third party patent information database, or may be stored locally or remotely. The computer system or systems that enable the user to interact with content or features can include a GUI (Graphical User Interface), or may include graphics, text and other types of information, and may interface with the user via desktop, laptop computer or via other types of processors, including handheld devices, telephones, mobile telephones, smartphones or other types of electronic communication devices and systems. A computer system for implementing the foregoing methods, functions, systems and computer-readable storage medium may include a memory, preferably a random access memory, and may include a secondary memory. Examples of a memory or a computer-readable storage medium product include a removable memory chip, such as an erasable programmable read-only memory (EPROM), a programmable read-only memory (PROM), removable storage unit or the like.

The communication interface of the system shown in the figures may include a wired or wireless interface communicating over TCP/IP paradigm or other types of protocols, and may communicate via a wire, cable, fire optics, a telephone line, a cellular link, a satellite link, a radio frequency link, such as WI-FI or Bluetooth, a LAN, a WAN, VPN, the world wide web or other such communication channels and networks, or via a combination of the foregoing.

While the preferred embodiments of the invention have been illustrated and described, modifications and adaptations, and other combinations or arrangements of the structures and steps described come within the spirit and scope of the application and the claim scope.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A landscape map populating, landscape management and automatic landscape management action signal generating method comprising:
populating an area of a map of a zone with information about a first plant associated with the area;
receiving from a first sensor located in the zone, by a module comprising an automated processor, first data regarding the first plant;
comparing, by the module comprising the automated processor, the first data with reference data of a plant of a same type as the first plant, and automatically making a determination, based on the comparing, regarding a landscape management action for the area; and
transmitting automatically a signal indicating the landscape management action for the area according to the determination.

2. The method of claim 1, wherein the first data represents an image of the first plant and the comparing comprises image processing to determine vigor of the first plant.

3. The method of claim 1, wherein the determining of the vigor is performed by judging a leaf width of the first plant.

4. The method of claim 1, wherein the determining of the vigor is performed by judging a leaf thickness of the first plant.

5. The method of claim 1, wherein the determining of the vigor is performed by judging a coloration of the first plant.

6. The method of claim 1, wherein the determining of the vigor is performed by judging a color of a tip or an edge of leaf or a blade of the first plant.

7. The method of claim 1, wherein the determining of the vigor is performed by judging an amount of coverage by the first plant of the first area.

8. The method of claim 1, wherein the determining of the vigor is performed by judging a folding of a leaf or blade of a first portion of the first plant with respect to midvein or central line of the first plant.

9. The method of claim 1, wherein the determining of the vigor is performed by judging the geometry of the blade according to a time of day trend determined.

10. The method of claim 1, wherein the plant is a grass.

11. The method of claim 1, wherein the method further comprises:
retrieving the reference data from a library remote from and, connected via a data network with, the module.

12. The method of claim 1, wherein the method further comprises:
receiving at a time remote from a time of the receipt of the first data, from the first sensor, second data regarding the first plant,
wherein the making the determination comprises judging a trend in a condition of the first plant by comparing the first data with the second data.

13. The method of claim 1, wherein the method further comprises:
judging a maturity of the leaf based on the first data,
wherein the making the determination is based on the maturity judged.

14. The method of claim 13, wherein the judging the maturity comprises:
determining a width of a blade or a leaf in relation to a length of the blade or the leaf.

15. The method of claim 1, wherein the method further comprises:
determining, based on the first plant, a landscaping supply list for the area; and
outputting the landscaping supply list to a user.

16. The method of claim 15, wherein the method further comprises:
populating the map with further information about the zone,
wherein the landscaping supply list comprises irrigation equipment, and the determining the landscaping supply list is based on the further information about the zone.

17. The method of claim 1, wherein the method further comprises:
generating an irrigation schedule according to the determination regarding the landscape management action.

18. The method of claim 1, wherein the signal is transmitted to at least one of an irrigation system, mowing equipment and trimming equipment.

19. A landscape map populating, landscape management and automatic landscape management action signal generating module comprising an automated processor communicatively connected to a first sensor located in a zone, the module comprising:
a populating data receiving module configured to receive populating data about a first plant associated with an area of a map of the zone;
a sensor data receiving module configured to receive, from the first sensor, first data regarding the first plant;
the sensor data receiving module configured to receive, from the first sensor, at a time remote from a time of the receipt of the first data, second data regarding the first plant;
an analyzer configured to compare automatically the first data with reference data of a plant of a same type as the first plant, and to judge a trend in a condition of the first plant by comparing the first data with the second data;
the analyzer configured to determine automatically, based on the judging, a landscape management action for the area; and
the module configured to transmit automatically a signal indicating the landscape management action according to the determination.

20. The module of claim 19, wherein the determining the landscape management action comprises deciding to irrigate the area when the trend shows declining vigor for the first plant.

21. A landscape map populating, landscape management and automatic landscape management action signal generating system comprising an automated processor communicatively connected to a first sensor located in a zone, the system comprising:
a populating data receiving module configured to receive populating data about a first plant and location data for associating the first plant with a first area of a map of the zone;
a sensor data receiving module configured to receive at a first time, from the first sensor, first data regarding a condition obtaining in the first area;
the sensor data receiving module configured to receive, from the first sensor, at a time subsequent to and remote from the first time, second data regarding the condition obtaining in the first area;
an analyzer configured to compare automatically the first data with the second data and to judge a trend in the condition in the first area;
the analyzer configured to determine automatically, based on the judging, a landscape management action for the area; and
the system configured to transmit automatically a signal indicating the landscape management action according to the determination.

22. The system of claim 21, wherein the trend judged comprises a change in a rut size in a ground in the first area.

23. The method of claim 21, wherein the trend judged comprises at least one of a change in a blade thickness of a grass, a change in a blade fold angle of the grass with respect to a midvein or central line, and a change in coloration of the grass.
